(19) United States
(12) Patent Application Publication
(10) Pub. No.: US 2024/0349928 A1
(43) Pub. Date: Oct. 24, 2024

(54) FOOD PREPARATION APPLIANCE, TOOL AND COVER OF SUCH AN APPLIANCE

(71) Applicant: HAMEUR, Luxembourg (LU)

(72) Inventors: Loic FEVRE, Luxembourg (LU); Julien BERTRAND, Luxembourg (LU)

(21) Appl. No.: 18/687,823

(22) PCT Filed: Aug. 31, 2022
(86) PCT No.: PCT/EP2022/074235

§ 371 Date: Feb. 29, 2024

(30) Foreign Application Priority Data
Sep. 1, 2021 (FR) FR2109147

(51) Int. Cl. A47J 19/02

(52) U.S. Cl. CPC A47J 19/027; A47J 19/023

(57) ABSTRACT

The appliance (20) for preparing foods is intended to produce fruit and/or vegetable juice from fruit and/or vegetables that are whole or in pieces. This appliance (20) comprises:
a rotating electric motor (21) mechanically connected to at least one basket (22) having an inner volume (23) delimited by cylindrical or conical peripheral walls of the basket, a volume into which the fruit and/or vegetables are introduced; and
a fixed tool (27) for recovering residues, comprising a ramp (28) positioned, in a permanent way during the operation of the appliance, close to the inner surface (29) of the basket, the ramp having, in the direction of rotation of the basket, a slope ascending to an upper surface (30) of the inner volume of the basket, such that the residues carried by the basket to the ramp move up the ramp to exit from the inner volume of the basket.

### TECHNICAL FIELD OF THE INVENTION

The present invention relates to an appliance for preparing foods, a tool and a cover for such an appliance. It applies, in particular, to the field of domestic, professional or commercial catering appliances.

### STATE OF THE ART

An electric juice extractor or an electric citrus press make it possible to extract juice from whole or cut fruit, by means of a rotating tool driven by an electric motor, for example a cone or a grater. The juice produced in this way then passes through a filter, in order to remove solid residues such as large pieces of pulp, seeds or the inner walls of the fruit being processed.

In professional machines, the filter is a rotary and comprises cylindrical or conical peripheral walls, to extract the juice by centrifugation. The efficiency is therefore significantly increased compared to simple fixed filters that can be found, for example, on the simplest citrus press, where only gravity operates, as is the case with the citrus press described in document FR 2 912 631. This rotating filter, also called a “basket”, can be attached to the tool, for example a press cone, for example forming a single mechanical part with this cone.

Document FR 2 912 631 describes such a citrus press that does not comprise a basket, i.e., as explained above, nor a rotating filter comprising cylindrical or conical peripheral walls making it possible to extract juice by centrifugation. On the contrary, the filter, called “ejection unit 90”, “takes the form of a disk” (page 16, line 11). The side wall 63 of the inner volume of this citrus press is fixed and comprises an opening 64 for ejecting waste thanks to a “deflector unit 93”.

In the case of machines not equipped with a residue removal system, the rotating filters take a cylindrical shape with vertical walls. The drawback is that the residues remain trapped in the basket, the efficiency thus declining progressively as they clog the filter and finally the machine must be regularly stopped in order to be able to empty the basket, or risk having the basket overflow, thus resulting in losses and splashes.

To remedy this, many professional machines comprise a system for continuously removing residues, thanks to a rotating filter taking a widely flared conical shape with sloping walls. The residues trapped by the filter then move up it by centrifugal force, until they overflow and fall, for example into a residue collection container.

However, the efficiency is significantly decreased for some applications by this device, in which the juice produced also tends to move up the filter instead of passing through it, to subsequently be discharged with the residues.

These applications therefore need to use a filter having more gently sloping, or even vertical, walls, which is not compatible with the system for continuously removing residues described above.

### PRESENTATION OF THE INVENTION

The present invention aims to remedy all or part of these drawbacks.

To this end, the present invention envisions, according to a first aspect, an appliance for preparing foods, intended to produce fruit and/or vegetable juice from fruit and/or vegetables that are whole or in pieces, which appliance comprises:
a rotating electric motor mechanically connected to at least one basket, a rotating filter comprising cylindrical or conical peripheral walls making it possible to extract juice by centrifugation, this basket having an inner volume (23, 43) delimited by the cylindrical or conical peripheral walls of the basket, a volume into which the fruit and/or vegetables are introduced and which is equipped with juice drainage openings, this basket rotating, in a rotational direction, around an axis of rotation;
a lower surface for receiving the juice flowing through the drainage openings of the basket; and
a fixed tool for recovering residues, comprising a ramp positioned, in a permanent way during the operation of the appliance, close to the inner surface of the basket, the ramp having, in the direction of rotation of the basket, a slope ascending to an upper surface of the inner volume of the basket opposite the lower surface, such that the residues carried by the basket to the ramp move up the ramp to exit from the inner volume of the basket.

Thanks to these provisions, the fruit or vegetable residues do not accumulate on the surface of the basket, which avoids clogging the juice drainage openings the basket is equipped with. The appliance that is the subject of the invention can therefore operate continuously in extracting the juice from a large number of fruit or vegetables. Because the tool is always in the appliance while it is operating, there is no break in this operation and a very large quantity of fruit or vegetables can be processed without having to interrupt the operation to empty the basket, as is the case with appliances not equipped with residue removal systems.

In some embodiments, the basket comprises at least one drive surface drawing the residues exiting from the ramp outside the inner volume of the basket.

In this way, the fruit or vegetable residues that have moved up the ramp as a result of the rotation of the basket are drawn by the drive surface and can be collected.

In some embodiments, the basket comprises, on the perimeter of its upper surface, a residue drive collar guiding the residues outside the inner volume of the basket.

In this way, the fruit or vegetable residues that have moved up the ramp as a result of the rotation of the basket are drawn by the collar and, by the action of the centrifugal force, are then ejected to be collected.

In some embodiments, the appliance also comprises a residue collection container whose opening is positioned outside the inner volume of the basket and close to the upper surface of the basket.

In this way, the collection container collects the fruit or vegetable residues that have moved up the ramp and have been drawn by a drive surface or collar. This collection container allows further processing of these residues, for example for their valorisation or disposal.

In some embodiments, the appliance also comprises a cover supporting the fixed residue recovery tool by positioning the ramp facing the inner surface of the basket at a predefined distance, the cover having a channel for inserting fruit and/or vegetables that opens into the inner volume of the basket, and also surfaces for guiding residues towards the opening of the collection container.

Thus, the tool is supported by the cover, avoiding a separate fixed support. It is therefore easy to remove and then clean the cover, tool and guide surfaces together at the same time.

In some embodiments, the appliance also comprises a moveable pusher in the insertion channel of the cover, this pusher having an outer shape corresponding to the shape of an inner wall of the channel, and a means for blocking a rotation of the pusher relative to an axis parallel to the axis of rotation of the basket.

Thus, the pusher is blocked in rotation by the means for blocking a rotation around an axis of the channel, and handles the torque needed to process the fruit or vegetable, preventing it from rotating with the basket.

In some embodiments, the channel comprises a wall supporting the residue recovery tool.

In this way, the residue recovery tool is incorporated into the cover.

In some embodiments, the channel comprises a cylindrical or conical wall, this wall opening into the inner volume of the basket, in which there is at least one plane perpendicular to the axis of rotation and the basket and passing through the inner volume of the basket, whose intersection with this wall is not circular.

Thus, the pusher is blocked in rotation by the channel, and handles the torque needed to process the fruit or vegetable, preventing it from rotating with the basket.

According to a second aspect, the present invention envisions a tool for recovering the residues from extracting juice from fruit and/or vegetables by an appliance that is the subject of the present invention.

According to a third aspect, the present invention envisions a cover of an appliance that is the subject of the present invention.

As the particular features, advantages and aims of this recovery tool and this cover are similar to those of the appliance that is the subject of the invention, they are not repeated here.

### BRIEF DESCRIPTION OF THE FIGURES

Other advantages, aims and particular features of the invention will become apparent from the non-limiting description that follows of at least one particular embodiment of the device that is the subject of the present invention, with reference to drawings included in an appendix, wherein:

FIG. 1 represents, schematically, partially, and in a vertical cross-section view, a first particular embodiment of the appliance that is the subject of the invention;

FIG. 2 represents, schematically, partially, and in a vertical cross-section view perpendicular to the cross-section of FIG. 1, the appliance illustrated in FIG. 1;

FIG. 3 represents, schematically, partially and in a top view, the appliance illustrated in FIGS. 1 and 2;

FIG. 4 represents, schematically, partially, in a perspective view, a second particular embodiment of the appliance that is the subject of the invention;

FIG. 5 is a partially exploded perspective view of the device illustrated in FIG. 3;

FIG. 6 is a perspective view from below of a cover that is the subject of the invention; and

FIG. 7 represents, schematically, a removal of residues from a ramp of a cover through a basket collar.

### DESCRIPTION OF THE EMBODIMENTS

The present description is given in a non-limiting way, in which each characteristic of an embodiment can be combined with any other characteristic of any other embodiment in an advantageous way.

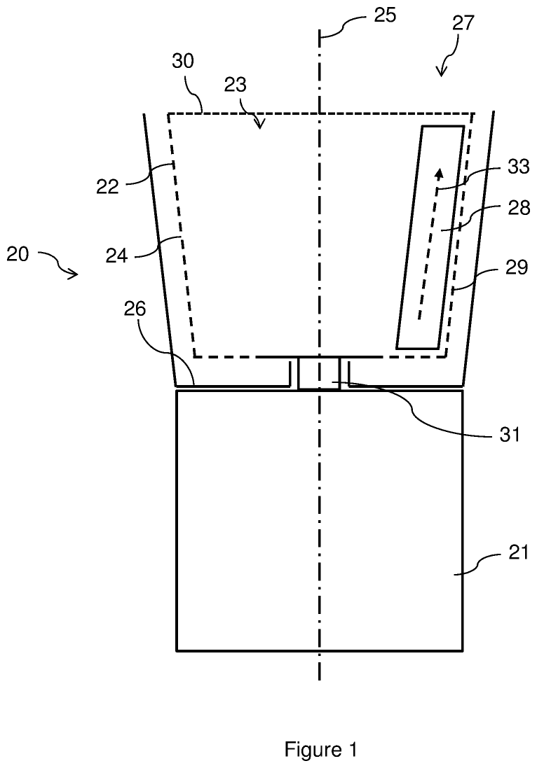

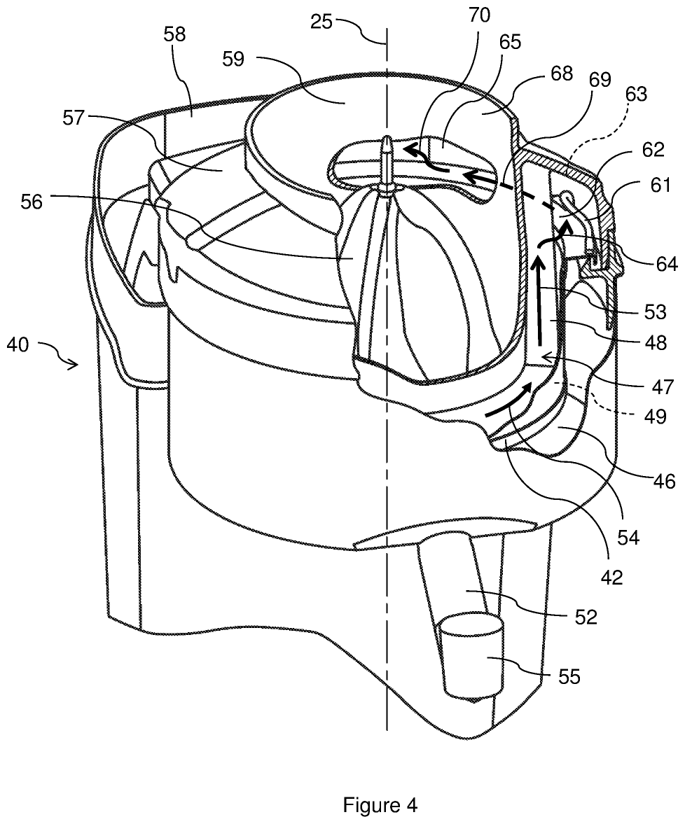

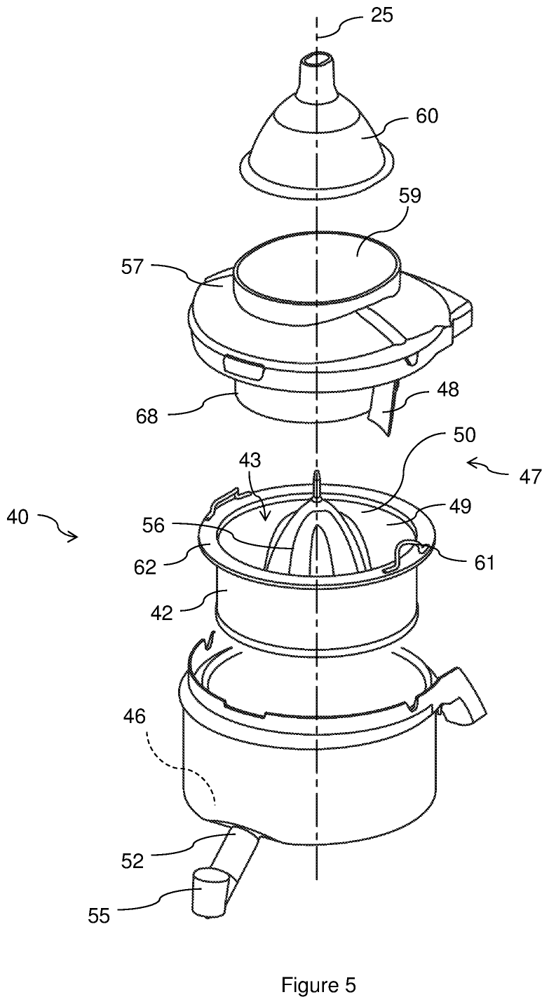

Note that FIGS. 1 to 3 and 7 are not to scale, but FIGS. 4 to 6 are each to scale and the scales of these FIGS. 4 to 6 may be different.

Throughout the description, the term “inner” or “central” refers to being located close to or oriented towards an axis 25 of the appliance, and “outer” refers to being located farther away from or oriented to the opposite of this axis. The term “top” or “upper” refers to being located at the top in the figures, these figures corresponding to the configuration of use for the appliance, gravity being exerted downwards in these figures. The term “bottom” or “lower” refers to being located at the bottom in these figures. The heights are defined from the bottom to the top in these figures.

FIGS. 1 to 3 show an appliance 20 for preparing foods, which produces fruit and/or vegetable juice from fruit and/or vegetables that are whole or in pieces.

The appliance 20 comprises, in the bottom portion, a rotating electric motor 21 that is connected by a mechanical connection 31, i.e. a shaft 31, to a basket 22. The basket 22 has an inner volume 23 delimited by cylindrical or conical peripheral walls of the basket, a volume into which the fruit and/or vegetables are introduced. The basket 22 is equipped with juice drainage openings 24. This basket 22 rotates, in a rotational direction, around an axis of rotation 25. The appliance 20 also comprises a lower surface 26 for receiving the juice flowing through the drainage openings 24 of the basket 22. Of course, more rounded shapes, e.g. spherical, of the peripheral walls of the basket 22 are here treated as a series of cylindrical or conical walls.

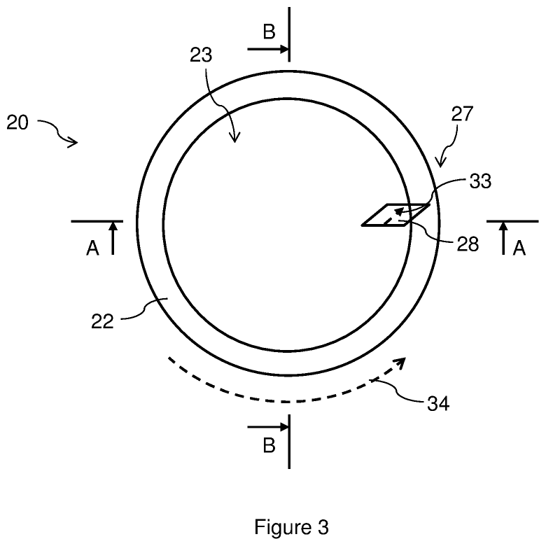

The appliance 20 further comprises a fixed tool 27 for recovering fruit or vegetable residues. The tool 27 comprises a ramp 28 positioned, in a permanent way during the operation of the appliance 20, close to an inner surface 29 of the basket 22. In a top view, in FIG. 3, the direction of rotation of the basket is counter-clockwise, as shown by the dashed arrow 34.

The ramp 28 has, in the direction of rotation of the basket 22, a slope ascending to an upper surface 30 of the inner volume 23 of the basket 22. As a result, the residues carried by the basket 22 to the ramp 28 move up the ramp 28 to exit from the inner volume 23 of the basket 22. The path of the residues on the ramp 28 is shown by the dashed arrow 33.

Note that the upper surface 30 is defined as the opening of the basket 22 located in the top plane.

A drainage 32 allows the juice to flow from the surface 26 receiving the juice to a juice outlet outside the appliance 20 or to a juice tank (not shown).

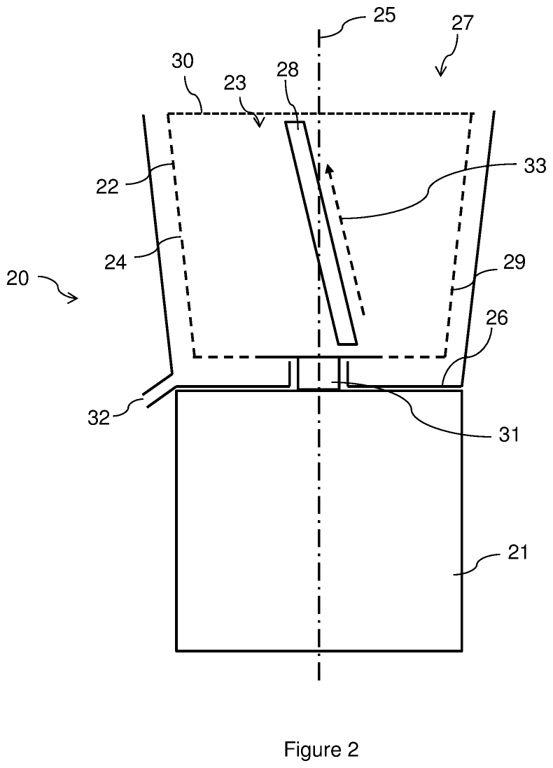

The cross-section according to which FIG. 1 is produced is the cross-section A-A shown in FIG. 3. The cross-section according to which FIG. 2 is produced is the cross-section B-B shown in FIG. 3.

FIGS. 4 to 7 show an appliance 40 for preparing foods, which produces fruit and/or vegetable juice from fruit and/or vegetables that are whole or in pieces.

The appliance 40 comprises, in the bottom portion, a rotating electric motor (not shown) that is connected by a mechanical connection (not shown) to a basket 42. The basket 42 has an inner volume 43 delimited by cylindrical or conical peripheral walls of the basket, a volume into which the fruit and/or vegetables are introduced. The basket 42 is equipped with juice drainage openings (not shown). This basket 42 rotates, in a rotational direction, around an axis of rotation 25. The appliance 40 also comprises a lower surface 46 for receiving the juice flowing through the drainage openings of the basket 42.

The appliance 40 further comprises a fixed tool 47 for recovering fruit or vegetable residues. The tool 47 comprises a ramp 48 positioned, in a permanent way during the operation of the appliance 40, close to an inner surface 49 of the basket 42. In a top view, the direction of rotation of the basket is counter-clockwise, also called anti-clockwise, as shown by the arrow 54.

The ramp 48 has, in the direction of rotation of the basket 42, a slope ascending to an upper surface 50 of the inner volume 43 of the basket 42. As a result, the residues carried by the basket 42 to the ramp 48 move up the ramp 48, following the path symbolised by the arrow 53, to exit from the inner volume 43 of the basket 42, following the path symbolised by the arrow 64.

Note that the upper surface 50 is defined as the opening of the basket 42 located in the top plane.

A drainage 52 allows the juice to flow from the surface 46 receiving the juice to a juice outlet 55 outside the appliance 50 or to a juice tank (not shown).

In addition to these elements, which have the characteristics of the corresponding elements shown in FIGS. 1 to 3, FIGS. 4 to 7 show a press cone 56 and a cover 57. In some embodiments (not shown), the press cone is not attached to the basket 42, for example not being formed as a single integral part with this basket, or not rotating at the same angular velocity or in the same direction as the basket.

Preferably, as in the embodiment shown in the figures, the press cone 56 is attached to the basket 42. For example, the basket 42 and the press cone 56 are comprised in a single part. According to a second example, the basket 42 and the press cone 56, produced in two mechanical parts that can be detached from each other, are attached by being driven by the same motor, at the same angular velocity and in the same direction of rotation.

The press cone 56 receives the fruit or the vegetable, typically a half citrus, subjected to a force from top to bottom. Because of the rotation of the press cone 56, part of the juice contained in the fruit or vegetable is extracted from it. The cover 57 comprises a central channel 59 for inserting fruit and/or vegetables, a channel that opens into the inner volume 43 of the basket 42. The fruit or the vegetable to be pressed is pushed through the channel 59 towards the press cone 56. A pusher 60, hand-held or mounted on a lever (not shown), allows the pressing force to be applied on the fruit or vegetable.

In the embodiment shown in FIGS. 4 to 7, the basket 42 comprises at least one drive surface 61 drawing the residues exiting from the ramp 48 outside the inner volume 43 of the basket 42, following the path symbolised by the arrow 64.

In this embodiment, the basket 42 comprises, on the perimeter of its upper surface, a residue drive collar 62 guiding the residues outside the inner volume 43 of the basket 42, following the path symbolised by the arrow 69.

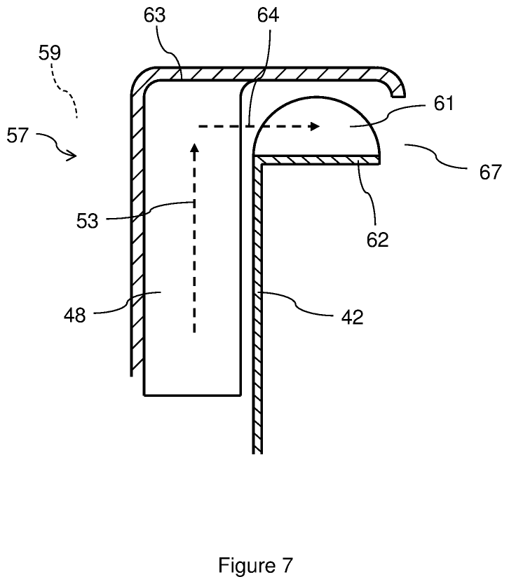

As shown in FIG. 7, when the residues move up the ramp 48 following the path symbolised by the arrow 53, they come closer to the lower surface 63 of the cover 57 and are pushed outwards along the path symbolised by the arrow 64. They therefore reach the drive collar 62 and, during passage of the drive surface 61, are drawn over this collar 62.

In the embodiment shown in FIGS. 4 to 7, the cover 57 supports the fixed residue recovery tool 47 by positioning the ramp 48 facing the inner surface 49 of the basket 42 at a predefined distance, for example, for the substantially vertical walls between zero and ten millimetres and for the lower wall between one and twenty millimetres. The cover 57 has surfaces 66 for guiding residues towards the opening 65 of a residue collection container 58. This opening 65 is positioned outside the inner volume 43 of the basket 42 and close to the upper surface of the basket 42.

Because of the centrifugal force, when these residues drawn by the collar 62 arrive opposite the opening of the collection container 58, they are ejected into this collection container 58, following the path symbolised by the arrow 70.

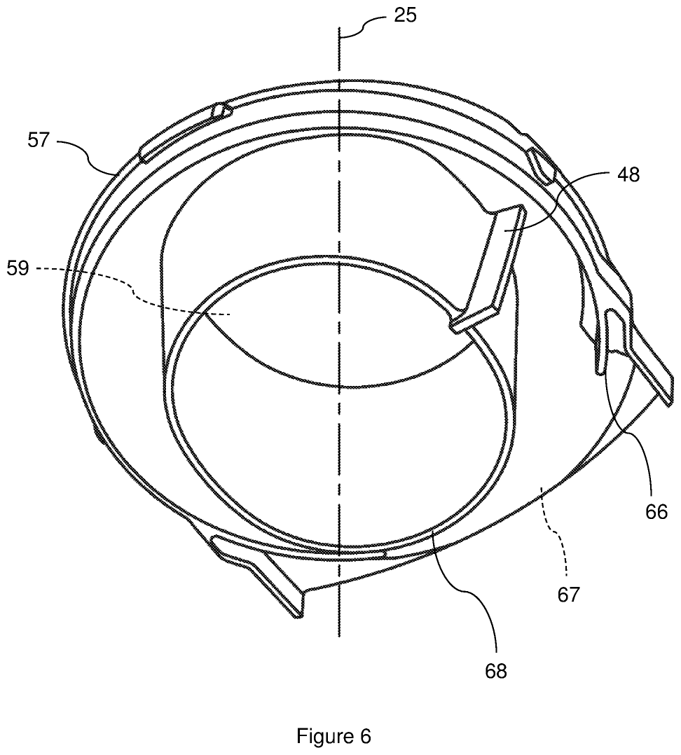

As shown in FIGS. 4 and 6, the insertion channel 59 of the cover 57 comprises a cylindrical or conical wall 68, this wall being positioned within the inner volume 43 of the basket 42 and supporting the residue recovery tool 47. In the embodiment shown in FIGS. 4 to 7, there is at least one plane perpendicular to the axis of rotation 25 of the basket 42 and passing through the inner volume 43 of the basket 42, whose intersection with this wall is not circular. In addition, the pusher 60 has an outer shape complementary to the cylindrical or conical wall 68 of the insertion channel 59 of the cover 57.

In other words, the appliance 40 comprises a fixed cover 57 equipped with a ramp 48 forming a scraper, which scrapes the inner edge of the rotating filter, or basket 42. This ramp 48 is sloped such that the residues, naturally driven by the rotation of the basket 42, move up this ramp 48 until they are caught by rotating blades 61 fixed on the upper portion of the basket 42. The fixed cover 57 comprises an opening 67 through which the residues are then evacuated by centrifugal force, to fall into the collection container 58 located at the rear of the appliance 40.

Other descriptions and variants of embodiment of the appliance and the cover that are the subjects of the invention are given below.

In some variants of embodiment, a blocking means (not shown), for example a lever, prevents any rotation of the pusher 60 relative to an axis parallel to the axis of rotation 25 of the basket 42. The pusher being blocked in rotation by this blocking means, it handles the torque needed to process the fruit or vegetable, preventing it from rotating with the basket 42.

Note that the ramp, 28 or 48, does not need to go beyond the inner volume 23 or 43 for the technical effect to be obtained. Indeed, the first role of this ramp, 28 or 48, is to remove the residues from the surfaces of the inner volume 23 or 43 to move these residues up until they are taken by drive means, for example blades, which can go beyond the inside of the inner volume 23 or 43 if the residues do not go beyond this by themselves.

The distance between the side edge of the ramp and the substantially vertical inner surface of the basket is as small as possible to maximise the scraping effect on this surface of the basket.

Note that each drive surface drawing the residues exiting from the ramp outside the inner volume 23 or 43 of the basket can take different forms, for example blades, lugs or projecting surfaces.

The present invention also envisions a tool and a cover configured to be used in a predetermined appliance for food preparation comprising
a rotating electric motor 21 mechanically connected to at least one basket 22 or 42, a rotating filter comprising cylindrical or conical peripheral walls making it possible to extract juice by centrifugation, this basket having an inner volume 23 or 43 delimited by the cylindrical or conical peripheral walls of the basket, a volume into which the fruit and/or vegetables are introduced and which is equipped with juice drainage openings 24, this basket rotating, in a rotational direction, around an axis of rotation 25; and
a lower surface 26 or 46 for receiving the juice flowing through the drainage openings of the basket.

The person skilled in the art can, on the basis of this predetermined appliance, and in particular on all of its geometric dimensions, realise without ambiguity the tool and the cover that are the subjects of the present invention.

1. Appliance for preparing foods, intended to produce fruit and/or vegetable juice from fruit and/or vegetables that are whole or in pieces, which appliance comprises:
a rotating electric motor mechanically connected to at least one basket, a rotating filter comprising cylindrical or conical peripheral walls making it possible to extract juice by centrifugation, this basket having an inner volume delimited by the cylindrical or conical peripheral walls of the basket, a volume into which the fruit and/or vegetables are introduced and which is equipped with juice drainage openings, this basket rotating, in a rotational direction, around an axis of rotation and
a lower surface for receiving the juice flowing through the drainage openings of the basket;
The appliance also comprises:
a fixed tool for recovering residues, comprising a ramp positioned, in a permanent way during the operation of the appliance, close to the inner surface of the basket, the ramp having, in the direction of rotation of the basket, a slope ascending to an upper surface of the inner volume of the basket opposite the lower surface, such that the residues carried by the basket to the ramp move up the ramp to exit from the inner volume of the basket.

2. Appliance according to claim 1, wherein the basket comprises at least one drive surface drawing the residues exiting from the ramp outside the inner volume of the basket.

3. Appliance according to claim 1, wherein the basket comprises, on the perimeter of its upper surface, a residue drive collar guiding the residues outside the inner volume of the basket.

4. Appliance according to claim 1, which also comprises a residue collection container whose opening is positioned outside the inner volume of the basket and close to the upper surface of the basket.

5. Appliance according to claim 4, which also comprises a cover supporting the fixed residue recovery tool by positioning the ramp facing the inner surface of the basket at a predefined distance, the cover having a channel for inserting fruit and/or vegetables that opens into the inner volume of the basket, and also surfaces for guiding residues towards the opening of the collection container.

6. Appliance according to claim 5, which also comprises a moveable pusher in the insertion channel of the cover, this pusher having an outer shape corresponding to the shape of an inner wall of the channel, and a means for blocking a rotation of the pusher relative to an axis parallel to the axis of rotation of the basket.

7. Appliance according to claim 5, wherein the channel comprises a wall supporting the residue recovery tool.

8. Appliance according to claim 5, wherein the channel comprises a cylindrical or conical wall, this wall opening into the inner volume of the basket, in which there is at least one plane perpendicular to the axis of rotation of the basket and passing through the inner volume of the basket, whose intersection with this wall is not circular.

9. Appliance according to claim 1, wherein the basket is attached to a press cone.

10. Appliance according to claim 9, wherein a single mechanical part comprises the basket and the press cone.

11. Tool for recovering the residues from extracting juice from fruit and/or vegetables, configured for a predetermined appliance for preparing foods, intended to produce fruit and/or vegetable juice from fruit and/or vegetables that are whole or in pieces, which appliance comprises a rotating electric motor mechanically connected to at least one basket, a rotating filter comprising cylindrical or conical peripheral walls making it possible to extract juice by centrifugation, this basket having an inner volume delimited by the cylindrical or conical walls of the basket, an inner volume into which the fruit and/or vegetables are introduced and which is equipped with juice drainage openings, this basket rotating, in a rotational direction, around an axis of rotation;
which tool comprises a ramp positioned, in a permanent way during the operation of the appliance, close to the inner surface of the basket, the ramp having, in the direction of rotation of the basket, a slope ascending to an upper surface of the inner volume of the basket opposite the lower surface, such that the residues carried by the basket to the ramp move up the ramp to exit from the inner volume of the basket.

12. Cover configured for a predetermined appliance for preparing foods, intended to produce fruit and/or vegetable juice from fruit and/or vegetables that are whole or in pieces, which appliance comprises a rotating electric motor mechanically connected to at least one basket, a rotating filter comprising cylindrical or conical walls making it possible to extract juice by centrifugation, this basket having an inner volume delimited by the cylindrical or conical walls of the basket, a volume into which the fruit and/or vegetables are introduced and which is equipped with juice drainage openings, this basket rotating, in a rotational direction, around an axis of rotation;
which cover supports a fixed residue recovery tool which comprises a ramp, the cover positioning the ramp facing the inner surface of the basket at a predefined distance, close to the inner surface of the basket, the ramp having, in the direction of rotation of the basket, a slope ascending to an upper surface of the inner volume of the basket opposite the lower surface, such that the residues carried by the basket to the ramp move up the ramp to exit from the inner volume of the basket;
the cover having a channel for inserting fruit and/or vegetables that opens into the inner volume of the basket, and surfaces for guiding residues towards the opening of the collection container.
